(19) United States
(12) Patent Application Publication
(10) Pub. No.: US 2004/0095738 A1
(43) Pub. Date: May 20, 2004

(54) Base plate for a light emitting diode chip

(76) Inventor: Der-Ming Juang, Taipei (TW)

Correspondence Address: Der-Ming Juang, P.O. Box No.6-57, Chung-Ho, Taipei, 235, TW

(21) Appl. No.: 10/294,674

(22) Filed: Nov. 15, 2002

(51) Int. Cl. H04B 1/03

(52) U.S. Cl. 361/815

(57) ABSTRACT

A base plate for a light emitting diode chip mainly including a base plate pressed and laminated with a circuit board is characterized that the base plate is made of an aluminum or copper plate; a printed circuit layer is disposed on the surface of the circuit board fixedly pressed on the base plate; at least one concave cup is disposed in the proper area on the surface of the circuit board; the concave cup penetrates from the printed circuit layer to the base plate. When applying the abovementioned assembly, it is necessary to fix a light emitting diode inside the concave cup; traces connect the light emitting diode chip to the printed circuit layer on the surface of the circuit board and are sealed firmly by a transparent adhesive. When the light emitting diode chip illuminates, the heat generated therefrom transmits directly from the bottom side of the concave cup to the base plate for dissipation.

### BACKGROUND OF THE INVENTION

1) Field of the Invention

The present invention relates to a base plate for a light emitting chip, more particularly to a metal base plate pressed and laminated with a circuit board; wherein the light emitting diode chip is disposed to penetrate into a concave cup of the metal base plate so as to augment the heat dissipation effect thereof.

2) Description of the Prior Art

Accordingly, a regular light emitting diode has a longer working life and consumes lower electricity. Therefore, the light emitting diode has been applied more popularly for a large sized electronic billboard, a traffic light and a vehicle signal light. The goal of the current trend of the light emitting diode industry is to produce it to have more brightness and lower light loss so as to substitute the traditional illuminating tools. However, in order to enhance the brightness and the power of the light emitting diode, not only the sealing structure and the material of the case thereof, but also the heat dissipation as the key influential factor of the useful power and life thereof have to be improved.

As indicated in FIG. 4, the conventional light emitting diode has a luminous element; wherein a concave cup (a11) is disposed at a distal end of one of two opposite connecting terminals (a1, a2). A light emitting diode chip (b) is fixed at the bottom side of the concave cup (a11) and connected to a top end of the other connecting terminal (a1) via a gold wire (c) to form an electric loop. The top ends of two connecting terminals (a1, a2) of the light emitting element is filled with adhesive for sealing thereby forming a transparent case (d) and a light emitting diode.

The abovementioned light emitting diode chip (b) generates heat in operation. Since it is disposed inside the concave cup (a11) at the top end of the connecting terminal (a1) and completely sealed inside the transparent case (d), the heat dissipation thereof is either very inefficient or unable to be conducted at all. Being in an environment with high temperature for a long term, the light emitting diode chip (b) is subjected to damage. However, to limit the electric pressure and current to be used by the light emitting diode chip (b) at a very low level fails to enhance the useful power and brightness thereof.

Furthermore, as indicated in FIG. 5, the structure of the luminous element of the conventional light emitting diode has one or more than one light emitting diode chip (b) disposed directly on a PC circuit board (e), connected to a printed circuit (e1) of the PC circuit board (e) via the gold wire (c) and sealed by a transparent resin (f).

The conventional PC circuit board (e) is made of insulating material without any heat conducting or dissipation effect. The bottom side thereof is disposed with copper platinum (e2) to communicate with an electrode on the top surface of the printed circuit (e1) such that the light emitting diode chip (b) directly adheres onto the printed circuit (e1) of the PC circuit board (e) for conducting the heat to the copper platinum (e2) thereby achieving the preferred heat dissipation, effect. However, in the conventional structure, the path or area for transmitting the heat from the printed circuit (e1) to the copper platinum (e2) is extremely small; furthermore, the volume of the copper platinum (e2) is extremely small and the heat absorption and dissipation thereof are not effective. In addition, usually an external case is added to the outer portion of the light emitting element to form an airtight space and that makes the heat dissipation even more difficult. Therefore, the conventional structure has to be improved.

### SUMMARY OF THE INVENTION

The primary objective of the present invention is to provide a base plate for a light emitting diode chip, wherein the base plate made of aluminum or copper material is the frame pressed by an insulating board (PC circuit board) disposed with a printed circuit layer; the light emitting diode chip is directly fixed on a concave cup of the base plate for directly transmitting the heat generated during light emission to the base plate for dissipation.

In order to achieve the above mentioned objective, the present invention mainly comprises the base plate made of either an aluminum or copper plate disposed with the printed circuit layer on the surface of the circuit board that presses fixedly the base plate.

When applying the abovementioned assembly, it is necessary to fix a light emitting diode chip inside the concave cup; traces connect the light emitting diode chip to the printed circuit layer on the surface of the circuit board and are sealed firmly by a transparent adhesive. When the light emitting diode chip illuminates, the heat generated therefrom transmits directly from the bottom side of the concave cup to the base plate to dissipate.

To enable a further understanding of achieving the abovementioned objective, features and advantages, the present invention is described by the brief description of the drawings followed by the detailed description of a preferred embodiment.

### BRIEF DESCRIPTION OF THE DRAWINGS

FIG. 1 is a pictorial and exploded drawing of a base plate for a light emitting diode chip of the present invention.

FIG. 2 is a schematic and cross-sectional drawing of the present invention.

FIG. 3 is a cross-sectional drawing of the assembled embodiment of the present invention.

FIG. 4 is a cross-sectional drawing of a conventional light emitting diode.

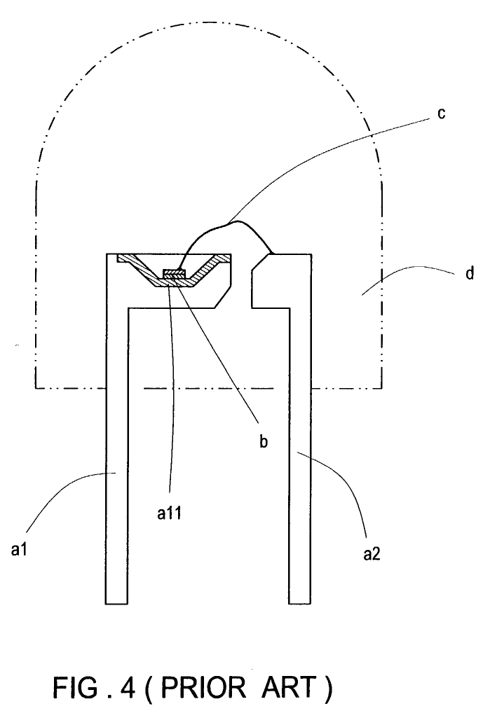

FIG. 5 is a cross-sectional drawing of a structural assembly of another conventional light emitting diode.

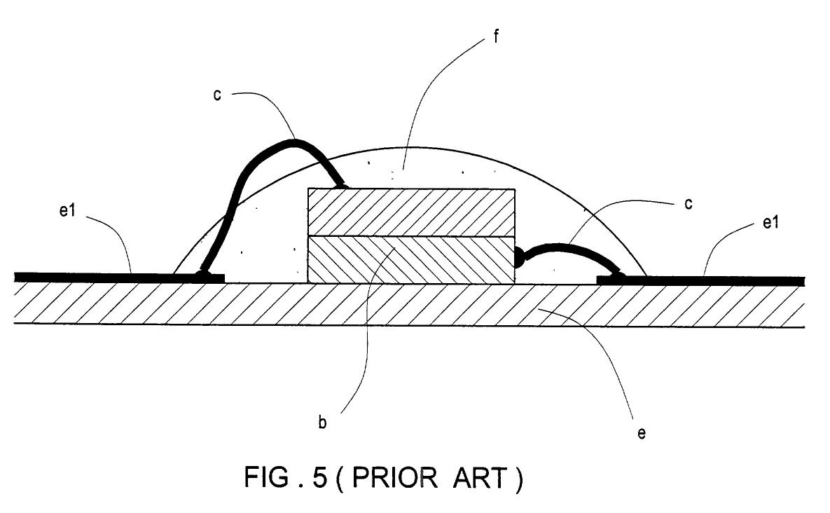

### DETAILED DESCRIPTION OF THE PREFERRED EMBODIMENTS

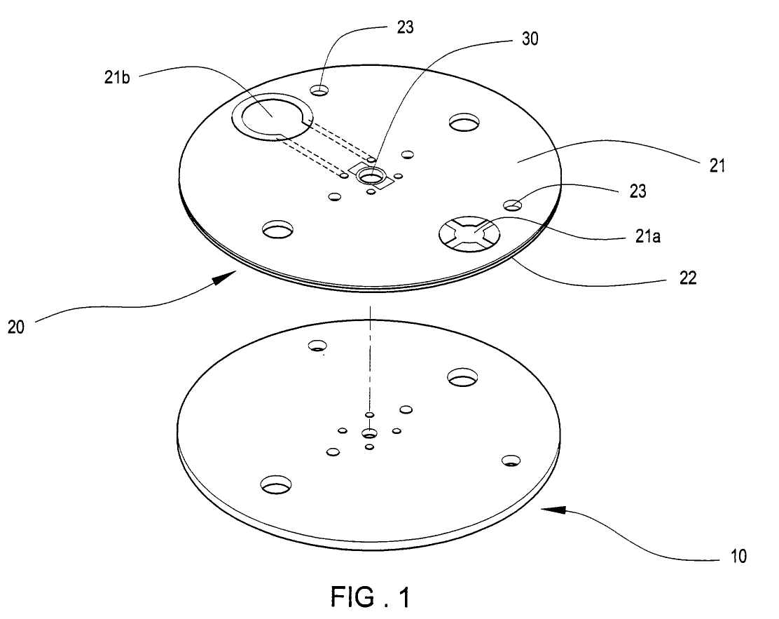

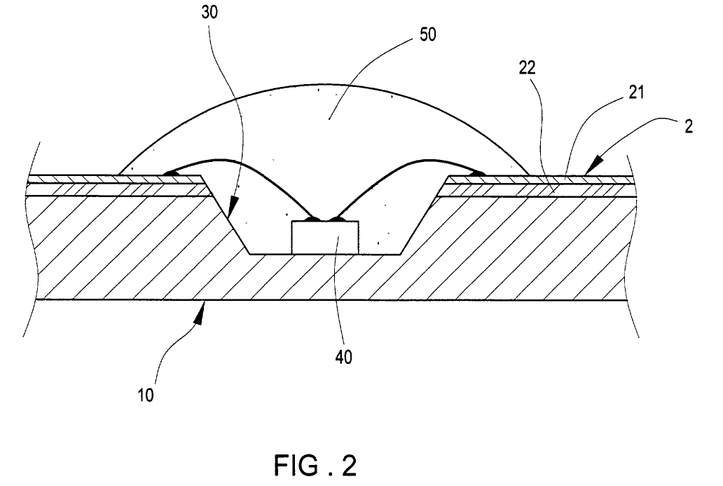

Referring to FIGS. 1 and 2, the present invention mainly comprises base plate (10) pressed and laminated with a circuit board (20). It is characterized that the base plate (10) is made of an aluminum or copper plate; a printed circuit layer (21) is disposed on the surface of the circuit board (20) fixedly pressed on the base plate (10); at least one concave cup (30) is disposed in the proper area on the surface of the circuit board (20); the concave cup (30) penetrates from the printed circuit layer (21) to the base plate (20).

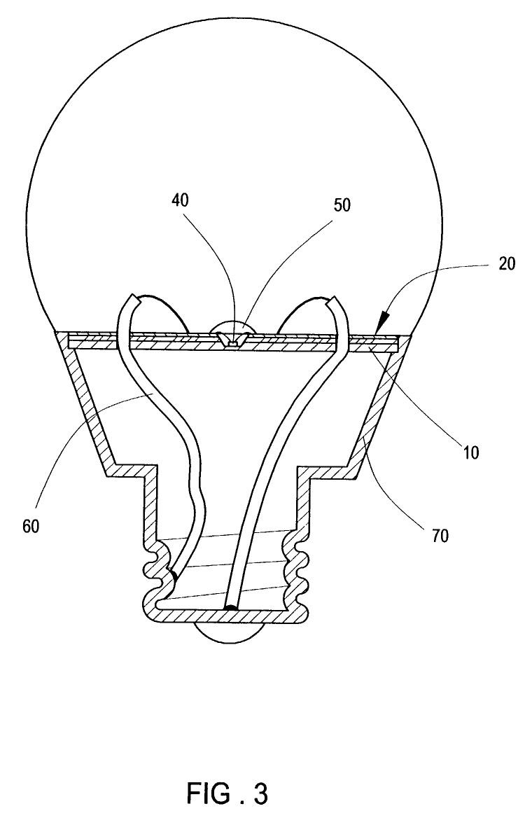

As indicated in FIG. 3, when using the present invention accordingly, it is necessary to dispose a light emitting diode chip (40) in the concave cup (30) penetrated to the metal base plate (10) via a silver adhesive; the light emitting diode chip (40) connects to a positive pole and a negative pole circuits of the printed circuit layer (21) via traces and it is firmly sealed by a transparent adhesive (50). When the light emitting diode chip (40) communicates with the electric current to emit the light, the heat generated therefrom directly transmits to the base plate (10) from the bottom portion of the light emitting diode chip (40) for achieving the best heat dissipation effect.

Referring to FIG. 1 again, in the embodiment, a positive pole (21a) and a negative pole (21b) circuits are designed to distribute in the printed circuit layer (21) on the surface of the circuit board (20); those circuits and the base plate (10) at the bottom layer are isolated completely via an insolating layer (22) of a circuit board (20). When in use, a conducting trace (60) goes through holes (23) on the base plate (10) and the circuit board (20). After the base plate (10) and the circuit board (20) are pressed into one unit, the holes (23) are drilled for respectively connecting the electric power to the input ends of the positive and negative poles (21a, 21b) of the printed circuit layer (21), as shown in FIG. 3. The structure of the present invention is directly fixed onto a metal lamp seat (70) of an illuminating tool; wherein the base plate (10) contacts the metal lamp seat (70) thereby increasing the heat dissipation effect without causing the electrical leakage situation but augmenting the practical effect thereof. In addition, the circuit board (20) of the present invention directly connects with a control IC or/and a voice IC (of a prior art and not described hereon) for extending the application scope thereof.

In summation of the abovementioned, the present invention of a base plate for a light emitting diode chip at least has the following advantages:

1. The present invention uses the light emitting diode chip to directly contact the base plate thereby providing an excellent heat dissipation path for the element.

2. The base plate of the present invention has larger heat absorbing volume and dissipation area for rapidly dissipating the heat generated by the light emitting diode chip.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A base plate for a light emitting diode chip mainly comprising a base plate pressed and laminated with a circuit board is characterized that:
the base pale is made of an aluminum or copper plate; a printed circuit layer is disposed on the surface of the circuit board pressed fixedly on the base plate; at least one concave cup is disposed in a proper area on the surface of the circuit board; the concave cup penetrates from the printed circuit layer to the base plate.

2. A base plate for a light emitting diode chip according to claim 1, wherein the base plate is completed isolated from the printed circuit layer located thereon via an insolating layer of the circuit board for not conducting the electricity.
